(19) United States
(12) Patent Application Publication
(10) Pub. No.: US 2015/0339609 A1
(43) Pub. Date: Nov. 26, 2015

(54) A METHOD AND A SYSTEM FOR MANAGING A CARGO STORAGE AREA

(71) Applicant: ISRAEL AEROSPACE INDUSTRIES LTD., Lod (IL)

(72) Inventors: Hanan LEPEK, Jerusalem (IL); Dani AGAMI, Petah Tikva (IL)

(21) Appl. No.: 14/655,009

(22) PCT Filed: Dec. 23, 2013
(86) PCT No.: PCT/IL2013/051054

§ 371 Date: Jun. 23, 2015

(30) Foreign Application Priority Data
Dec. 27, 2012 (IL) 223988

(51) Int. Cl. G06Q 10/06; G06Q 10/08

(52) U.S. Cl. CPC G06Q 10/06312; G06Q 10/083

(57) ABSTRACT

A method for managing storage of a group of containers in a cargo storage area, is provided, the group is characterized by one or more parameters for each container. The method comprising: selecting among the parameters at least one parameter as a basis for selecting storing configuration for the group. The storing configuration are one of a first storing configuration which allows direct access to each one of the containers and a second storing configuration which allows direct access only to some of the containers. The method further comprising selecting one of the configurations based on the at least one parameter.

### TECHNOLOGICAL FIELD

The presently disclosed subject matter relates to a method for managing a cargo storage area in general, and in particular to a method for managing an automated storage such as a container terminal.

### BACKGROUND

Shipping freight via containers remains a cost effective way transport goods globally. Typically, many such containers are transported on a marine vessel and unloaded at a port. The containers are then stored at or near the port, until trucks arrive to transport each container to its intended location. Alternatively, in the case of transshipment the container is unloaded to a port from one vessel, stored at the port for a period of time and loaded back to another vessel.

Between the time the containers are unloaded from the marine vessel and transported by the truck, the containers are stored. The containers are typically stacked in a container yard. The height of each stack can be limited by the weight of the containers and their strength, the type of equipment being used for lifting each container and by other parameters of the containers, although usually they do not exceed six containers.

Since different containers are stored in the port for different period of times the extraction thereof is not carried out at the same time. Thus, in this case a specific container must be retrieved from a stack of container. Typically it is desirable to store a group of containers which are interceded to be extracted from the storage area at the same time, for example if all the containers in the group have the same destination. However, in practice, containers arrive somehow randomly and relevant data, like weight information, is not always given at that time, and thus, they are stored somewhat randomly.

Retrieval of each container involves identifying the location of a desired container among the stacks, and, if necessary, relocating containers which are above it in order to retrieve the desired container for placement on a truck.

FIG. 1 illustrates an example of reshuffling of containers stored in an area required for extracting containers (G, H, J, C) therefrom.) Accordingly a four or five containers must be lifted and relocated in the stack in order to extract the containers G, H, J, and C. This process is however time and resourced consuming.

WO 2011/104716 discloses a method of transferring a plurality of containers to storage. the method comprises providing at least one multi-level structure with an elevator configured to receive and transport one or more containers thereupon and being configured to ascend and descend to a predetermined level, each of the levels comprising a plurality of bays being sized to receive and store therein one of the containers; providing a plurality of unmanned autonomous guided vehicles (AGV) configured to perform forward/backward and sideways movements and to receive a container thereupon; receiving each of the containers on a receiving AGV (rAGV) of the AGVs; and positioning the rAGV with the container received thereby in a target bay on a target level of the structure.

FIG. 2 is a perspective view of the multi-level structure of the storage system disclosed in WO 2011/104716. The multi-level structure 2, includes a plurality of autonomous guided vehicles (AGVs) 4, and a control system 6. The structure 2 is typically constructed in the vicinity of a marine shipping dock, for example in a terminal container. The structure 2 comprises a plurality of levels 8, and an elevator shaft 5 spanning therebetween.

Although, according to this example containers are not stacked up generally, however, in order to extract a container which is not directly accessed through a path, or an elevator, containers located next to it must be reshuffled.

### General Description

According to one aspect of the presently disclosed subject matter there is provided a method for managing storage of a group of containers in a cargo storage area, the group is characterized by one or more parameters for each container. The method comprising: selecting among the parameters at least one parameter as a basis for selecting storing configuration for the group. The storing configuration are one of a first storing configuration which allows direct access to each one of the containers and a second storing configuration which allows direct access only to some of the containers. The method further comprising selecting one of the configurations based on the at least one parameter.

In case the second storing configuration is selected, the method further comprises determining among the parameters at least one parameter as a basis for determining required accessibility for each container in the group and selecting based thereon the location of each container with respect to other containers in the group.

The at least one parameter for determining required accessibility for each container in the group can be different than the at least one parameter for selecting storing configuration for the group.

Selecting one of the configurations can include selecting the first storing configuration in case information regarding the at least one parameter is not available for the group of containers. In addition, selecting one of the configurations can include selecting the second storing configuration in case all the containers in the group share the same parameter.

According to another aspect of the presently disclosed subject matter there is provided a method for managing the storage of a plurality of containers in a cargo storage area having a plurality of zones, the containers being characterized by one or more parameters for each container. The method comprising: selecting among the parameters at least one parameter as a basis for dividing the plurality of containers into one or more groups of containers and dividing the plurality of containers into groups. The method further comprises selecting a storing configuration for each one of the groups of containers. The storing configuration are one of a first storing configuration which allows direct access to each container in the group and a second configuration which allows direct access only to some containers in the group. The method further comprises allocating at least one zone in the storage area for storing at least one of the groups of containers, the zone being configured for storing therein the group in the selected storing configuration.

In case the second storing configuration is selected for one or more of the groups, the method further comprises determining among the parameters at least one parameter as a basis for determining required accessibility for each container in the group to which it pertained and selecting based thereon the location of each container with respect to other containers pertaining to the same group.

The at least one parameter for determining required accessibility for each container in the group can be different than the at least one parameter for selecting storing configuration for the group.

The at least one zone can be one zone allocated for storing therein two or more groups, and the first storing configurations can selected for storing at least one of the two or more groups in the one zone.

The containers which the at least one parameter thereof is not available can be grouped into at least one group and the first configuration can be selected therefor. The containers which share the same parameter can be grouped into at least one group and the second configuration can be selected therefor.

The at least one parameter can be at least one of the following: the destination, the weight, and the required storage time of each of the containers.

Selecting one of the configurations can further comprise considering the cost difference between the first storing configuration and the second storing configuration. The cost includes the cost of maneuvering containers and the cost of space in the storage area.

According to a further aspect of the presently disclosed subject matter there is provided a system for managing storage of a group of containers in a cargo storage area, the group being characterized by one or more parameters for each container. The system comprises a multi-level structure with an elevator configured to receive and transport one or more containers thereupon. The elevator is configured to ascend and descend to a predetermined level, each of the levels comprising a plurality of zones configured to store therein the group of containers. The system further comprises a plurality of unmanned autonomous guided vehicles (AGV) configured to perform front/back and sideways movements and to receive a container thereupon.

The system further comprises a controller configured for selecting among the parameters at least one parameter as a basis for selecting storing configuration for the group. The storing configuration are one of a first storing configuration which allows direct access to each one of the containers and a second storing configuration which allows direct access only to some of the containers. The controller is further configured for selecting one of the configurations based on the at least one parameter, and allocating at least one of the plurality of zones for storing therein the group in the selected configuration.

The controller can be configured, in case the second storing configuration is selected, to select among the parameters at least one parameter as a basis for determining required accessibility for each container in the group and selecting based thereon the location of each container with respect to other containers in the group in the at least one zone.

The controller can be configured to determine the required accessibility for each container on the basis of a parameter which is different than the at least one parameter for selecting storing configuration for the group.

The controller can be configured for selecting the first storing configuration in case information regarding the at least one parameter is not available for the group of containers.

The controller can be configured for selecting the second storing configuration in case all the containers in the group share the same parameter.

As used herein after, the term ‘container’ refers to a freight container for holding any kind of cargo or any kind of a body having an inner volume for holding cargo.

As used herein after, the term ‘direct access’ refers to an access in and out of a physical location within a storage area, in which a container is disposed, without having to move any other similar container horizontally or vertically disposed between the location and an access path leading out of the storage area.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic illustration of a prior art method of extracting a container from a stack of containers;

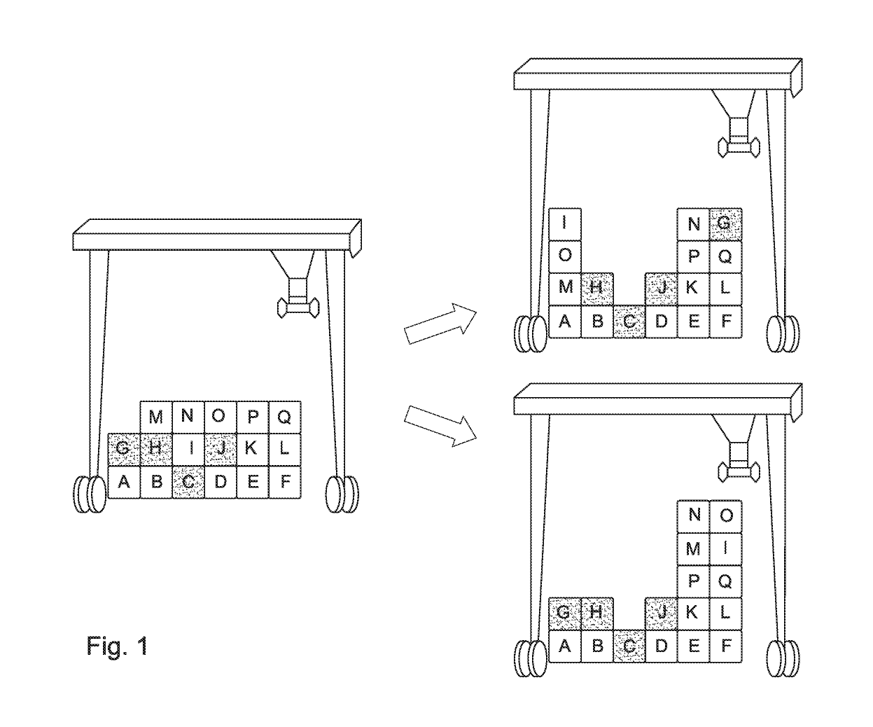

FIG. 2 is a perspective view of a prior art multi-level structure of the storage system;

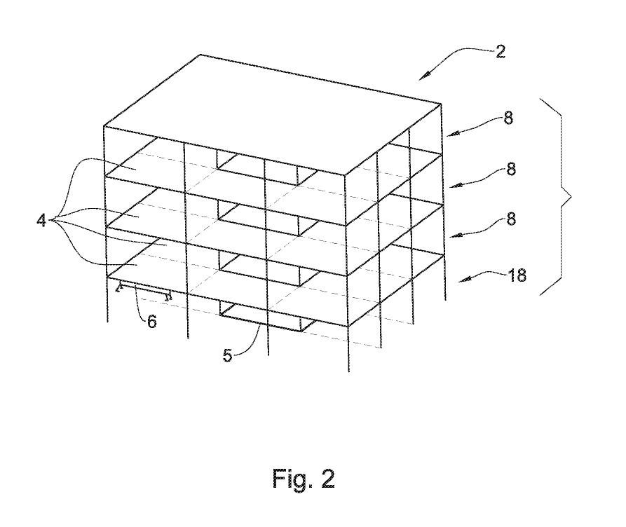

FIG. 3 is a schematic illustration of a storage area having a group of containers stored therein in a first storage configuration;

FIG. 4 is a schematic illustration of the storage area of FIG. 3 having a group of containers stored therein in a second storage configuration;

FIG. 5 is a schematic illustration of the storage area of FIG. 3 having a plurality of groups of containers stored therein in a first and second storage configuration;

FIG. 6A is a schematic illustration of a floor in a multilevel storage of FIG. 3 having a plurality of groups of containers stored therein in a first and second storage configuration;

FIG. 6B is a schematic illustration of a floor in a multilevel storage of FIG. 3 having a plurality of groups of containers stored therein in a first and second storage configuration;

FIG. 7 is a flow chart diagram of a storage management process in accordance with one example of the presently disclosed subject matter; and,

FIG. 8 is a flow chart diagram of a storage management process in accordance with one example of the presently disclosed subject matter.

### DETAILED DESCRIPTION OF EMBODIMENTS

The presently disclosed subject matter provides a method for managing storage of a group of freight containers in a cargo storage area. The area can be for example a portion of a container terminal in a sea port. Each container in the group is characterized by one or more parameters such as weight, destination, and expected storage time in the container terminal. It is appreciated that the parameters can be any parameter which affects the order in which the containers departs the terminal, for example to be loaded on a vessel. That is to say, in case the heavy containers are to be loaded first on the sea vessel and it is desirable to have these containers depart the terminal before the lighter containers, and thus the storage location of the heavy containers should be such which allows the extraction thereof first.

According to the method one or more of the group's parameter is selected as a basis for determining the desirable accessibility of each container. In order to allow the flexibility of determining the accessibility of each container in the group the storing configuration for the entire group is selected. The storing configuration can be a first storing configuration which allows direct access to each one of the freight containers, hereinafter ‘full accesses configuration’, and a second configuration which allows direct access only to some of the freight containers in the group, hereinafter ‘clustered configuration’. Selecting the storing configuration of the group is selected based on at least one parameter, for example the destination of the containers.

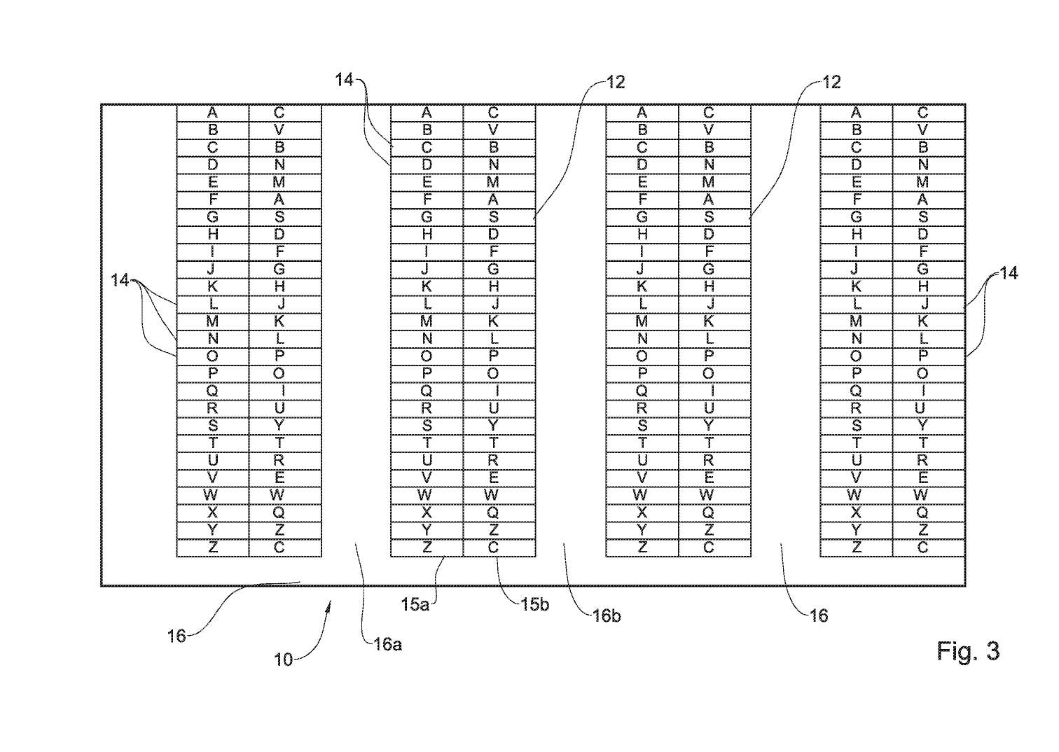

FIG. 3 is a schematic illustration of a storage area 10 configured for storing a first group of freight containers, generally designated 12. The containers 14 of this group 12 are arranged in the area 10 in a first configuration providing a full access, such that each of the containers has a direct access, for example by a container crane or an autonomous guided vehicle such as the autonomous guided vehicle disclosed in WO2011/104716. In order to allow direct access to each container 14, an access path 16 is defined between the containers. In the illustrated example the containers are arranged such that two columns of containers 15a and 15b are adjacent one another, having a first access path 16a defined on one side of the pair of columns and a second path 16b is defined on the other side of the pair of columns. This way, each one of the containers 14 in the pair of columns 15a and 15b is directly accessible through either one of the first or second paths 16a and 16b.

In this case the storing configuration of the group 12 in the area 10 provides a direct access to each one of the containers 14. This configuration can be selected when characteristics of the containers 14 in the group 12 vary from one another, for example the destination thereof. Thus, in the latter case the destination is the parameter selected as a basis for determining storing configuration for the group 12. Since each container 14 has a different destination (designated by a letter), it is hard to predict the order in which the containers are to be extracted from the area and loaded to a marine vessel, thus the full access configuration is selected, providing a direct access to each one of the containers 14 in the group 12. It is appreciated that even if few containers 14 in the group share an identical destination, the first configuration, namely the full accesses configuration can still be selected since the vast majority of the containers in the group 12 require direct access.

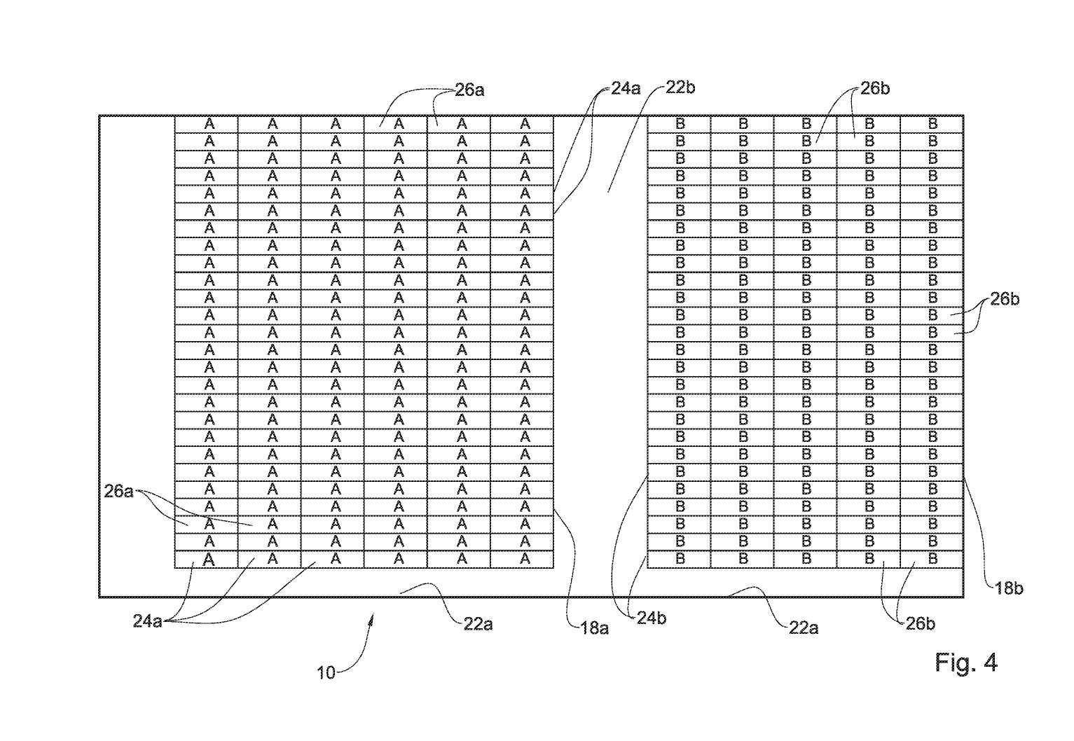

Turning now to FIG. 4, illustrating the storage area 10 having a first and a second groups of freight containers 18a and 18b stored therein, and arranged in a second configuration, namely, a clustered configuration wherein only some of the containers are provided with a direct access while the other containers can not be accessed without moving first some other containers. The clustered configuration allows storing some containers in a direct access position, while other containers are stored in an indirect access position. According to this configuration the containers of the first group 18a which are provided with a direct access can be characterized as directly accessible containers 24a, while the other containers can be characterized as indirectly containers 26a.

According to the illustrated example, the configuration provides a path 22a in the area 10, extending along directly accessible containers 24a, and can further provides an additional path 22b extending between the first group 18a and the second group 18b, thus increasing the number of directly accessible containers.

In the case illustrated in FIG. 4 the first group 18a includes containers 24a and 26a which share a parameter, for example a destination designated by the letter A, thus the second configuration is selected. That is to say, since all the containers 24a and 26a are assumed to be extracted together, for instance for loading on one marine vessel or to any other destination such as an inland location, the indirectly accessible containers 26a, can be accessed once the directly accessible container 24a adjacent the paths 22a or 22b are extracted from the storage area 10. This way, there is substantially no need to shuffle any one of containers 24 in order to access an indirectly container 26a.

In the illustrated example the second group 18b includes containers 24a and 26a which share a parameter, for example a destination designated by the letter B, or any other parameter such as a range of weights. The parameter B which is shared by the containers of the second group 18b can be the same or different than the parameter A shared by the containers of the first group 18a. For example both parameters A and B can represent the destination of the respective containers, in which case, destination A is different than destination B. Alternatively, the parameter A shared by the containers of the first group 18a can represent the destination thereof, which is the same for all the containers of in the first group 18a, while parameter B shared by the containers of the second group 18b can represent the weight thereof (or the range of weights) which is the same for all the containers of in the second group 18b The weight of the container can be determined by the type of the container body, by the freight stored therein and/or by the amount of freight stored therein.

Thus, the area 10 is divided such that one side thereof is occupied by the containers 24a and 26a of the first group having the parameter A and a second side thereof is occupied by the containers 24b and 26b of the second group 18b having the parameter B. Containers 24b and 26b are arranged in a similar way of the arrangement of containers 24a and 26a. Thus, since containers 24b and 26b share the parameter B are assumed to be extracted together, for instance for loading on one marine vessel, the indirectly accessible containers 26b, can be accessed once the directly accessible containers 24b are extracted.

It is appreciated that in order to allow access to containers 26a sharing the parameter A, as well as to the containers 26b sharing the parameter B, the paths 22a or 22b extends along at least one of the directly accessible containers 24a and 24b. Thus, following the extraction of directly accessible containers 24a and 24b, the indirectly accessible containers 26a and 26b can be accessed respectively.

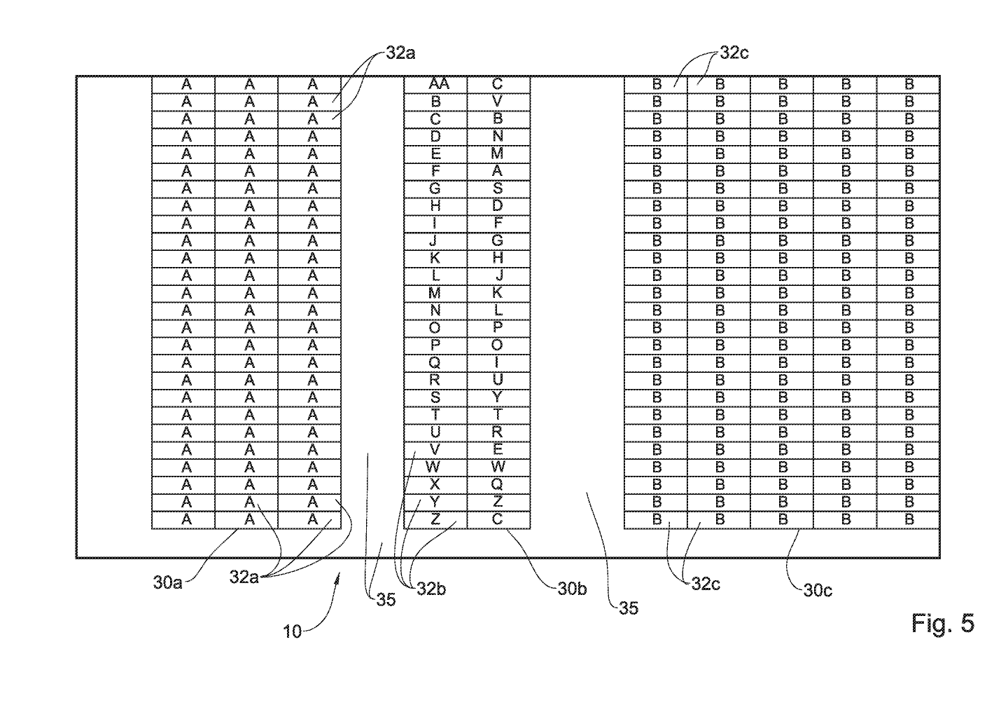

Reference is now made to FIG. 5 showing area 10 this time storing a first group of containers 30a, a second group of containers 30b and a third group of containers 30c. According to this example the first and third groups of containers 30a and 30c stored in area 10 are stored in the second configuration, providing some of the containers 32a and 32c with a direct access while other containers therein are indirectly accessed. The containers 32b of the second group 30b on the other hand are arranged in the first configuration providing all the containers with a direct access.

The area according to this example is provided with path 35 which is configured to allow a direct access to all the containers 32b of the second group 30b and to further allow accesses to some of the containers of the first and third groups 30a and 30c.

In the case illustrated in FIG. 5 the containers 32a of the first group 30a share a parameter, such as weight, destination, etc, here designated A, thus it is assumed that all the containers 32a are to be extracted substantially at the same time. Accordingly, the first group 30a is arranged in the second configuration, since all the containers thereof are extracted together precluding the need for shuffling thereof.

Similarly, the containers 32c of the third group 30c share a parameter, such as weight, destination, etc, here designated B, which can be different than parameter A of the first group 30a. Thus it is assumed that all the containers 32b are to be extracted substantially at the same time. Accordingly, the third group 30c is arranged in the second configuration, since all the containers thereof are extracted together precluding the need for shuffling thereof.

On the other hand the containers 32b of the second group 30b which do not share the same parameter, for example the weight or destination thereof varies from another, thus the order in which the containers 32b are extracted from the storage area 10, may vary due to unexpected events such as a change in a vessel arrival time etc. In order preclude the need to re-shuffle the containers 32b in case a specific container has to be extracted, the containers are stored in the first configuration providing each container 32b with a direct access.

It is appreciated that the path 35 provided between the containers of each of the groups 30a, 30b and 30c, can be configured to serve two groups at the same time. For example, the path 35 can be extended between the first group and the second group 30a and 30b.

According to the presently disclosed subject matter the method can be implanted in managing a multilevel storage structure such as described in WO2011/104716. Accordingly each floor can be arranged such the containers stored therein are stored in the first configuration or the second configuration or a combination thereof.

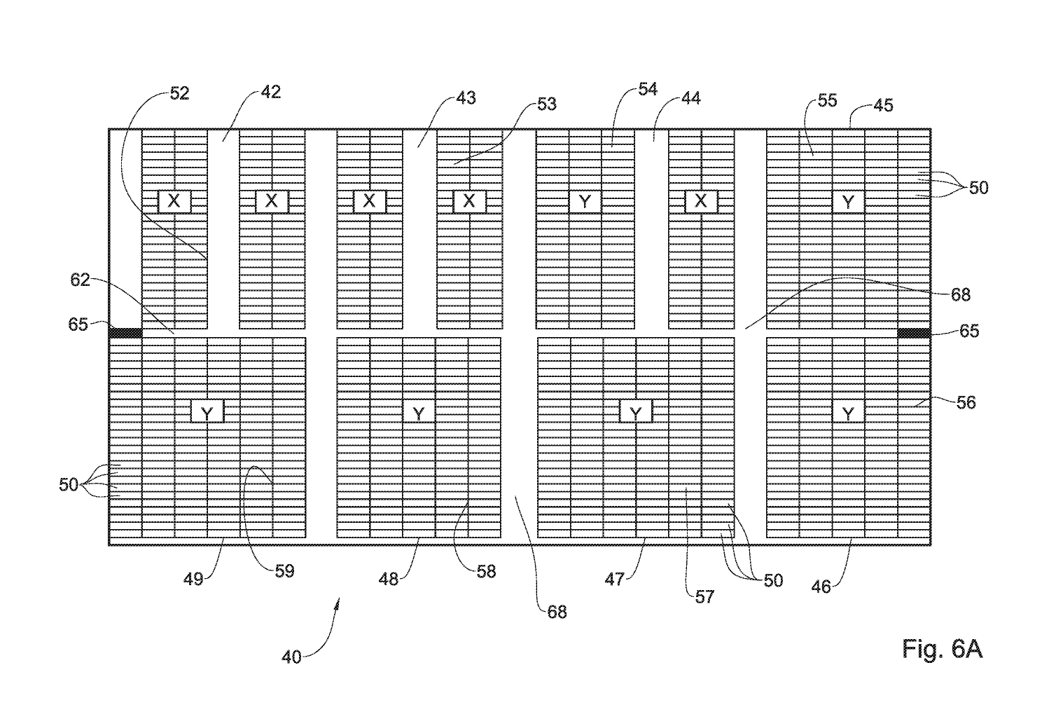

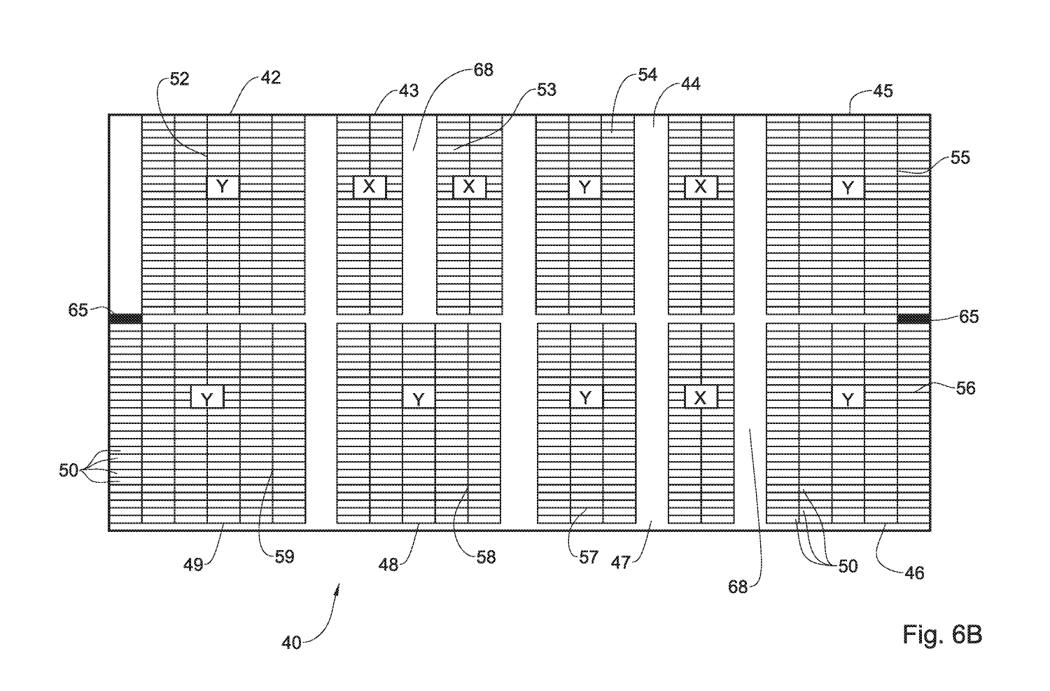

FIG. 6A illustrates a floor 40 of a multilevel storage structure, having a plurality of zones 42 through 49 each configured to store a group of containers. The zones can be of a predetermined size, or can be such which the size thereof changes in accordance with the storage requirements of other zones, as is explained herein after. It is appreciated that the zone size can be subjected to some technical restrictions, such as support pillars vertically extending throughout the structure. In addition, in case the structure includes one or more elevators 65 for maneuvering the containers between floors, the location of the elevators can limit the size of the zones defined around it. The floor 40 further includes paths 68 extending from the elevators 65 and between the zones and within the different zones depending on the selected storage configuration therein.

In the illustrated example each one of zones 42 through 49 is occupied with containers 50 arranged in groups 52 through 59 respectively. Zones 42 and 43 are occupied with groups 52 and 53 which are arranged in the first configuration (designated X), namely the full access configuration.

Zones 45 through 49 are occupied with groups 55 through 59, respectively each of which includes containers 50 arranged in the second configuration (designated Y), namely the clustered configuration.

Zone 44 according to this example, is occupied with group 54 which includes containers 50 arranged in the first configuration (designated X) and other containers arranged in the first configuration (designated Y).

As explained here in above the decision whether to store a group of containers in the first configuration or in the second configuration is carried out by selecting at least one parameter of the containers as a basis for determining the storing configuration for that group.

In addition, for groups arranged in the second configuration B, the location of each container within the zone with respect to other containers in the same zone can be determined for example based on one parameter affecting the required accessibility therefore. For example in case of zone 49 where group 59 is arranged in the second configuration B, the containers 50 can share the same destination, thus when the containers are extracted from the zone 49 the contraries located adjacent the path 68 can be extracted first, following which the next line of containers are extracted without having to re-shuffle any container. However, in case it is desirable to first load on the marine vessel, the heavy containers directed to a certain destination, and only then to load the light containers directed to the same destination, the heavy containers can be located closer to the path 68 within zone 49. Thus, when the vessel is loaded the containers are extracted one after the other without having to reshuffle the containers so as to load the heavy containers first.

Turning now to FIG. 6B, floor 40 according to the presently disclosed method can be dynamically managed in the sense that group of containers which are stored in one storage configuration can be dynamically shifted to a different storage configuration based on the varying parameters and conditions in the container terminal. For example, in the illustration of FIG. 6B, floor 40 is substantially in the same storing position as illustrated in the position of FIG. 6A, however, with regards to zone 42, it can be seen that in the position illustrated in FIG. 6B is slightly re-arranged. In this position, two columns of containers 50 are added to group 52 stored in zone 42, thus changing the storage configuration from a full access configuration to a clustered configuration. This change can be carried out for example as a result of a change in a marine vessel schedule, affecting the required accessibility of the containers in the zone 42.

For instance, if some containers are to be shipped by one vessel while other containers are to be shipped by another vessel, the direct access configuration can be selected as in the position illustrated in FIG. 6A. However, in case the schedule of the vessel is changed and all the containers 50 of group 52 stored in zone 42 are to be shipped by one vessel, accessibility of the containers in the zone can be changed accordingly, and the zone can be arranged in the clustered configuration as illustrated in FIG. 6B.

It is appreciated that since this change provides additional storage space inside zone 42, the position change in the floor 40 can be determined considering the cost of the maintaining open space for forming an access path for any given time period. In addition, the cost of maneuvering the containers 50 so as to change the storage configuration from that of position of FIG. 6A to that of FIG. 6B should be considered to.

According to another example, a group of containers which may be admitted into the container terminal, however without much information regarding its destination, or weight etc., can be stored inside the storage area in a direct access configuration. Similarly, when the loading sequence of the containers on the vessel becomes available only shortly before the loading process, the containers can be stored in a direct access configuration until the loading sequence is provided.

Once more information regarding the containers in the group is received the containers can be re-arranged for example dividing them into different groups and storing those which share parameters in the clustered configuration.

According to a further example illustrated in FIGS. 6A and 6B, the storage configuration of a portion of group 57 stored in zone 47, can be dynamically changed from the clustered configuration illustrated in FIG. 6A to a configuration combining the free access and clustered configuration as shown in FIG. 6B, thereby providing more accessibility to some of the containers therein. This can be carried out for instance, if a change in the loading order of a vessel has changed and lighter containers are required to be loaded first. That is to say, if in the position illustrated in FIG. 6A the heavier containers are located in a more accessible location in the zone 47, a change in the required loading order can require that lighter containers should be loaded first. Thus can occur for instance due to an unpredictable event according to which the lighter containers are to be loaded on a different vessel than the one originally planed. Thus instead of re-shuffling the entire group 57 so as to extract the lighter containers first, one column of containers can be removed from the zone, thereby forming a path and providing a direct access to the lighter containers.

Here too, the cost of maneuvering the one column of containers out of the zone 47 and the cost of dedicating a different storage space for the containers of this column should be considered with respect to the cost and time required for re-shuffling in case the re-arrangement of the group 57 is not carried out.

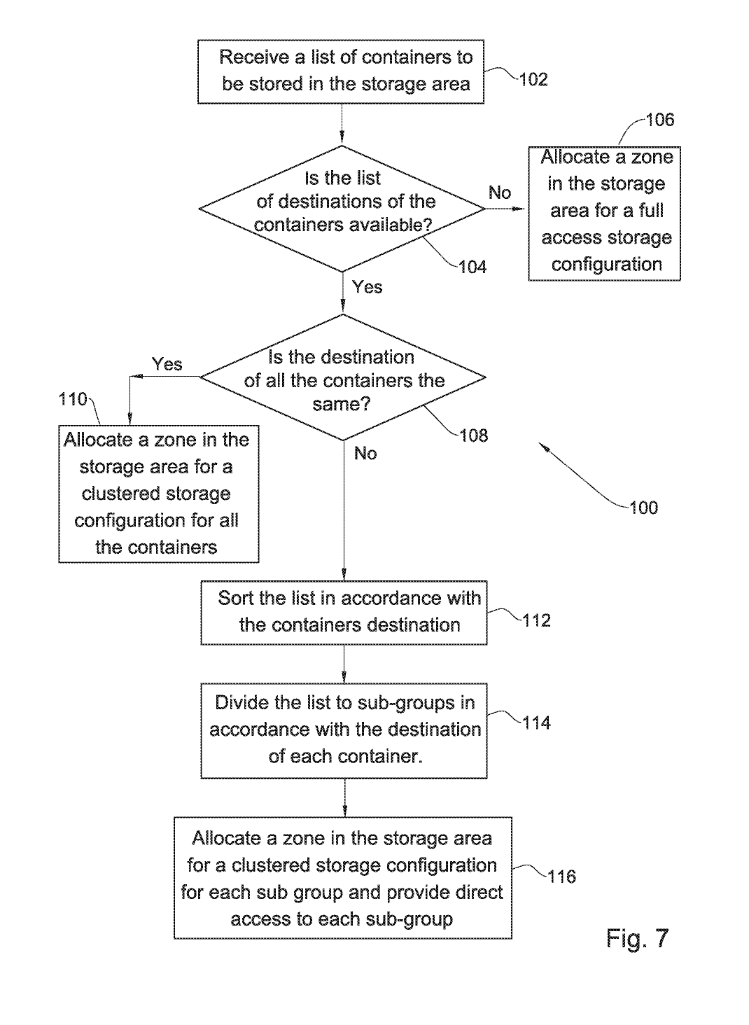

FIG. 7 is a flow chart 100 exemplifying the process of storing a group of containers. The controller, which can be a computer, receives a list of containers to be stored in the storage area (block 102), the containers can be containers received from one sender, or one vessel, or can be containers received from different senders vessels. The containers in this process can be treated as a group of containers for example, if for some reason it is desirable to store them in the same area in the terminal. Otherwise, each container can be treated separately as described hereinafter. Since the containers are characterized by various parameters which can affect the required accessibility thereof, the controller first determines among the parameters at least one parameter as a basis for selecting storing configuration for the group. In the illustrated flow chart 100 the destination of each container is selected as the parameter which affects the required accessibility of the containers. Thus, if the list of destinations of each container is not available (block 104), the controller allocates a zone in the storage area for a full access storage configuration (block 106). Thus, when the destination of each container is received each container is accessible without having to move any other container, such which has a different destination.

However, if the list of destinations of each constrainer is available the controller considers whether all the containers in the list are directed to the same destination (block 108). In the latter case, the controller allocates a zone in the storage area for storing all the containers in the group in a clustered storage configuration (block 110). In this case, the containers are assumed to be extracted at the same time, thus the accessibility of each container within the group can be randomly determined.

In case the containers in the list do not share the same destination, the controller sorts the list in accordance with the destinations (block 112), following which the list can be divided to various sub-groups in accordance with the destination of each container (block 114). The controller then allocates a zone in the storage area for each sub-group to be stored in a clustered storage configuration (block 116). The sub-groups can be stored in the same zone or can be stored in two different zones depending on space availability in the entire storage area or any other factor.

The controller can also assign an access path for a direct access to each sub-group. It is appreciated that each container in each sub-group need not be provided with a direct access, since it is assumed according to this example, that all the containers in the sub-group are to be extracted from the storage are substantially at the same time, thus no shuffling in the sub-group is required.

It is further appreciated that in case a first sub-group is scheduled to be extracted after a second sub-group the first sub-group does not have to be provided with a direct access, rather, the container of the first sub-group can be clustered behind the containers of the second sub-group. This way, once the second group is extracted out of the storage area, the first sub-group can be accessed directly.

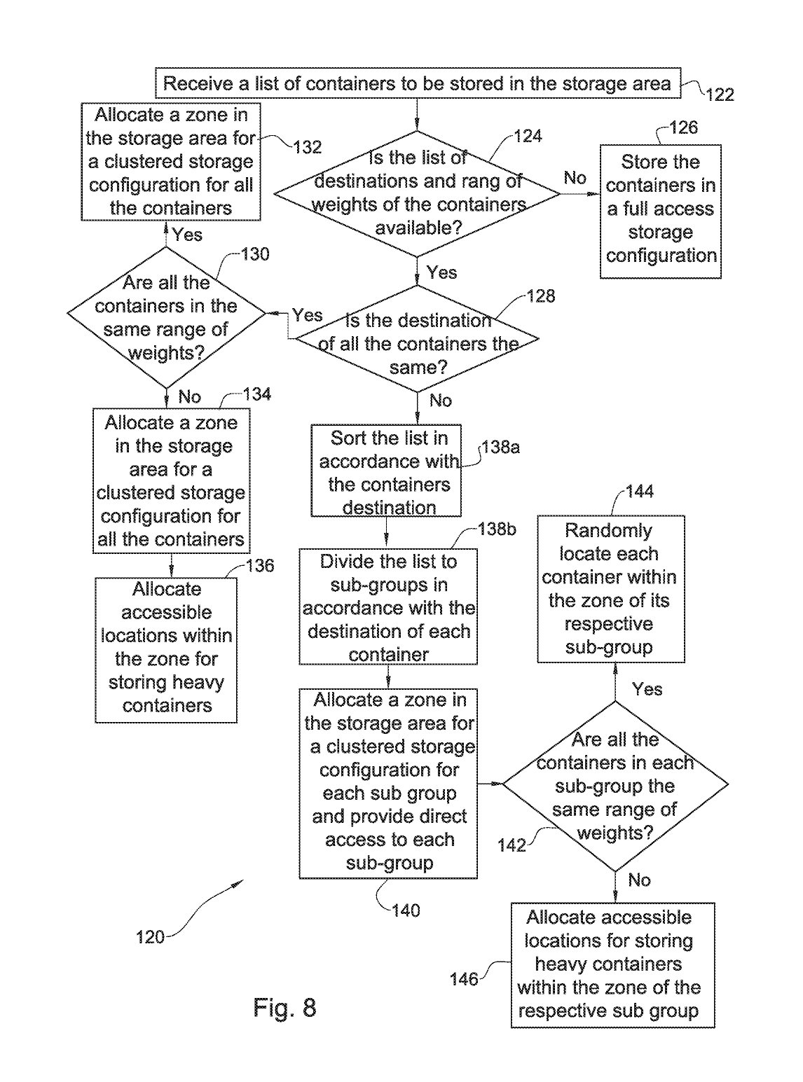

FIG. 8 is a flow chart 120 showing another example of a process of storing a group of containers. As in the previous example, the controller, receives a list of containers to be stored in the storage area (block 122), and determines among the parameters of the containers at least one parameter as a basis for selecting storing configuration for the group. As in the previous example the destination of each container is selected as the parameter which affects the required accessibility of the containers. However, according to this example the range of weights of each container is also considered. For the sake of this example, the range of weights is a range in which all the containers are treated as one group of containers. This is due to the fact that the weight of the container is considered when loading a vessel, during which the heavy containers are loaded substantially at the bottom of the stack of containers and the lighter containers are loaded at the top thereof, so as to preclude a large momentum caused by winds around the vessel. However, in order to appropriately plan the location of each container in the stack on the vessel it is sufficient to define to which range of weight each container pertains.

If the list of destinations and the weight of each container is not available (block 124), the controller allocates a zone in the storage area for a full access storage configuration (block 126). This way, when the destination of each container is received each container is accessible without having to move any other container, such which has a different destination.

If however, the list of destinations and weight of each constrainer is available the controller considers whether all the containers in the list are directed to the same destination (block 128). In the latter case, the controller considers the weight of each container (block 130), and if all the containers in the group are in the same range of weights, the controller allocates a zone in the storage area for storing all the containers in the group in a clustered storage configuration (block 132). In this case, the containers are assumed to be extracted at the same time, thus the accessibility of each container within the group can be randomly determined.

In case, the containers in the group are of different weight which are not in the same range of weights the controller allocates a zone in the storage area for storing all the containers in the group in a clustered storage configuration (block 134). However, since the containers are of various weights the extraction thereof should be in the order depending on the weight thereof, thus the controller can allocate accessible locations within the zone for storing heavy containers (block 136). This way, when the group of containers is extracted from the storage area, the heavy containers are extracted first and loaded onto the vessel first. Once the heavy containers are extracted from the zone, the other containers in the group can be accessed too. It is appreciated that not all the heavy container have to be located in an accessible location within the zone, rather the heavy containers should be located such that the extraction thereof can be carried out without shuffling lighter containers, for example, by locating the sub-group of light containers behind the sub-group of heavy containers. It is appreciated that alternatively, the location of each individual container with respect to other containers in the group can be determined based on any other parameter.

In the case the containers in the list do not share the same destination, the controller sorts the list in accordance with the destinations (block 138a), following which the list can be divided to various sub-groups in accordance with the destination of each container (block 138b), as described with respect to the example of FIG. 7. The controller then allocates a zone in the storage area for each sub-group to be stored in a clustered storage configuration (block 140). The controller can also assign an access path for a direct access to each sub-group.

According to this example the controller further considers whether all the containers in each sub-group are of the same range of weights (block 142), in which case the controller randomly locates each container within the zone of its respective sub-group (block 144). However, if the containers in each sub-group are not of the same range of weights, and thus should be extracted and loaded onto a vessel in a specific ordered as required, the controller allocates accessible locations for storing heavy containers within the zone of the respective sub group (block 146), so that these containers can be accessible for loading thereof on a vessel prior to the lighter containers.

It is appreciated that although the above description is focused on a process carried out with regards to a group of containers, a similar process can be carried out with respect to a single container (i.e. a group consists of a single container). For example, if a container is received, the controller can select a parameter characterizing the container, such as the destination thereof, which can be the basis for selecting storing configuration for the container. Thus, for example, the controller can decide to store the container in a zone which is arranged in the first configuration, wherein all the containers stored therein have a direct access, thereby providing the container with a direct access. However, if the destination of the container is known the controller can decide to store the container in a zone arranged in the second configuration, namely the clustered configuration, with other containers having the same destination. The container can be located within the selected zone in a location with respect to other containers in the zone in accordance with the required accessibility thereof, for example based on the destination or any other parameter.

As mentioned hereinabove, the parameters based on which the storage configuration of a group of containers as well as the accessibility of each container is determined, can be the destination of the container, the weight thereof, the expected storage time. In addition, since in the first storage configuration fewer containers per area unit can be stored, the cost of allocating the space for this storage configuration can be considered as well, especially with respect to the reshuffling time and cost in case the clustered configuration is selected. In addition, the vessel intended to ship the container can also vary from a container to a container even when directed to the same destination, thus the intended vessel can also be a parameter based on which the storage configuration is determined.

In addition, any other parameter which can affect the required accessibility of a container or a group of containers can be taken into consideration. It is appreciated that for the sake of the destination as referred to in this description can be also a shipping line to one or more areas. Thus, containers in a group of one shipping line can be stored in the clustered configuration since they are loaded to the same vessel. However, the location of each container within the zone in which the group of containers is stored can be selected so that the respective location on the vessel allows taking the container off the vessel at its destination without reshuffling other containers.

It is appreciated that a system for managing a multi-level structure such as disclosed in WO 2011/104716 incorporated herein by reference can be provided. The system can include a multi-level structure having a plurality of autonomous guided vehicles (AGVs), and a control system. The controller determines among the parameters of a group of containers at least one parameter as a basis for selecting the storing configuration for the group. The storing configuration is one of a first storing configuration which allows direct access to each one of the containers and a second configuration which allows direct access only to some of the containers. The configuration can be applied on each floor of the multi-level structure, or on zones within each floor. The controller further selects one of the configurations based on the at least one parameter.

Those skilled in the art to which the presently disclosed subject matter pertains will readily appreciate that numerous changes, variations, and modifications can be made without departing from the scope of the invention, mutatis mutandis.

1-27. (canceled)

28. A method for managing storage of a group of containers in a cargo storage area, the group of containers being characterized by one or more parameters for each container of the group of containers, the method comprising:
selecting among the one or more parameters at least one parameter as a basis for selecting a storing configuration for the group of containers, the storing configuration being one of a first storing configuration that allows direct access to each of the containers or a second storing configuration that allows direct access only to some of the containers; and
selecting one of the first or second storing configurations based on the at least one parameter.

29. The method of claim 28, further comprising:
when the second storing configuration is selected, determining among the one or more parameters at least one parameter as a basis for determining a required accessibility for each container in the group of containers and selecting based thereon a location of each container of the group of containers with respect to other containers in the group of containers.

30. The method of claim 29, wherein the at least one parameter for determining the required accessibility for each container in the group of containers is different than the at least one parameter for selecting the storing configuration for the group of containers.

31. The method of claim 28, wherein selecting one of the first or second storing configurations based on the at least one parameter includes selecting the first storing configuration when information regarding the at least one parameter is not available for the group of containers.

32. The method of claim 28, wherein the selecting one of the first or second storing configurations based on the at least one parameter includes selecting the second storing configuration when all of the containers in the group of containers share the same parameter.

33. The method of claim 28, wherein the at least one parameter is at least one of the following: a destination, a marine vessel, weight, or a required storage time of each of the containers.

34. The method of claim 28, wherein the selecting one of the first or second storing configurations includes considering a difference in cost between the first storing configuration and the second storing configuration.

35. The method of claim 34, wherein the cost includes a cost of maneuvering containers and a cost of space in the storage area.

36. A method for managing the storage of a plurality of containers in a cargo storage area having a plurality of zones, the plurality of containers being characterized by one or more parameters for each of the plurality of containers, the method comprising:
selecting among the one or more parameters at least one parameter as a basis for dividing the plurality of containers into one or more groups of containers and dividing the plurality of containers into groups;
selecting a storing configuration for each one of the one or more groups of containers, the storing configuration being one of a first storing configuration that allows direct access to each of the containers in the group or a second storing configuration that allows direct access only to some containers in the group;
allocating at least one zone in the cargo storage area for storing at least one of the one or more groups of containers, the at least one zone being configured for storing therein the group in the selected storing configuration.

37. The method of claim 36, further comprising:
when the second storing configuration is selected for one or more of the one or more groups, determining among the one or more parameters at least one parameter as a basis for determining a required accessibility for each container in the group to which it pertained and selecting based thereon a location of each container with respect to other containers pertaining to the same group.

38. The method of claim 37, wherein the at least one parameter for determining the required accessibility for each container in the group is different than the at least one parameter for selecting the storing configuration for the group.

39. The method of claim 36, wherein the at least one zone is one zone allocated for storing therein two or more groups.

40. The method of claim 36, wherein the selecting one of the first or second storing configurations includes considering a difference in cost difference between the first storing configuration and the second storing configuration.

41. The method of claim 40, wherein the cost includes a cost of maneuvering containers and a cost of space in the storage area.

42. A system for managing storage of a group of containers in a cargo storage area, the group being characterized by one or more parameters for each container, the system comprising:
(a) a multi-level structure having an elevator configured to receive and transport one or more containers thereupon and being configured to ascend and descend to a plurality of predetermined levels, each of the plurality of predetermined levels including a plurality of zones configured to store therein the group of containers;
(b) a plurality of unmanned autonomous guided vehicles configured to perform front/back and sideways movements and to receive a container thereupon; and
(c) a controller configured for selecting among the one or more parameters at least one parameter as a basis for selecting a storing configuration for the group of containers, the storing configuration being one of a first storing configuration that allows direct access to each one of the containers or a second storing configuration that allows direct access only to some of the containers; and further configured for selecting one of the first or second storing configurations based on the at least one parameter, and allocating at least one of the plurality of zones for storing therein the group in the selected configuration.

43. The system of claim 42, wherein when the second storing configuration is selected, the controller is further configured to select among the one or more parameters at least one parameter as a basis for determining a required accessibility for each container in the group and selecting based thereon the location of each container with respect to other containers in the group in the at least one zone.

44. The system of claim 42, wherein the controller is further configured for determining the required accessibility for each container on the basis of a parameter being different than the at least one parameter for selecting storing configuration for the group.

45. The system of claim 42, wherein the controller is further configured for selecting the first storing configuration when information regarding the at least one parameter is not available for the group of containers.

46. The system of claim 42, wherein the controller is further configured for selecting the second storing configuration in case all the containers in the group share the same parameter.

47. The system of claim 42, wherein the at least one parameter is at least one of the following: a destination, a vessel, weight, or a required storage time of each of the containers.
